(19) United States
(12) Patent Application Publication
(10) Pub. No.: US 2010/0156887 A1
(43) Pub. Date: Jun. 24, 2010

(54) Extended user interface

(75) Inventors: Sanna Lindroos, Tampere (FI); Sanna Maria Koskinen, Tampere (FI); Heli Jarventie-Ahonen, Tampere (FI); Katja Smolander, Tampere (FI); Jarkko Saunamaki, Vantaa (FI); Alexander Budde, Helsinki (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation

(21) Appl. No.: 12/317,190

(22) Filed: Dec. 18, 2008

(51) Int. Cl. G06F 3/041; G06T 1/00; G09G 5/00

(52) U.S. Cl. 345/418; 345/173; 345/1.3

(57) ABSTRACT

An apparatus including a housing having an exterior including a first display face and a second display face arranged such that it is contiguous to the first display face; and a processor configured to define a graphical user interface distributed simultaneously over both the first display face and the second display face.

### FIELD OF THE INVENTION

Embodiments of the present invention relate to an extended user interface. In particular, they relate to extended user interfaces for hand-portable apparatuses.

### BACKGROUND TO THE INVENTION

There are a number of common forms of hand portable electronic devices with displays.

One form has a display and dedicated keys. A problem with this form is that many dedicated keys may need to be provided which may reduce the available display size.

One form has a touch sensitive display. A problem with this form is that only a limited number of touch sensitive keys can be provided in the display at a time.

One form has a display and permanent keys with programmable functions. A problem with this form is that parts of the display adjacent to the permanent keys are required to identify the current function of a key.

It would be desirable to provide a new form of hand-portable electronic device.

### BRIEF DESCRIPTION OF VARIOUS EMBODIMENTS OF THE INVENTION

According to various, but not necessarily all, embodiments of the invention there is provided an apparatus comprising: a housing having an exterior comprising a first display face and a second display face contiguous to the first display face; and a processor configured to define a graphical user interface distributed simultaneously over both the first display face and the second display face.

According to various, but not necessarily all, embodiments of the invention there is provided an apparatus comprising: housing means having an exterior comprising a first display face and a second display face contiguous to the first display face; and processor means for defining a graphical user interface distributed simultaneously over both the first display face and the second display face.

According to various, but not necessarily all, embodiments of the invention there is provided a method comprising: distributing a graphical user interface simultaneously over both a first display face of an apparatus and a second display face of the apparatus, wherein the apparatus has an exterior comprising the first display face and the second display face contiguous to the first display face; and detecting an input from at least one of the first display face of the apparatus and the second display face of the apparatus.

According to various, but not necessarily all, embodiments of the invention there is provided a computer program which when executed by a processor enable the processor to: distribute a graphical user interface simultaneously over both a first display face of an apparatus and a second display face of the apparatus, wherein the apparatus has an exterior comprising the first display face and the second display face contiguous to the first display face; and process an input from at least one of the first display face of the apparatus and the second display face of the apparatus.

According to various, but not necessarily all, embodiments of the invention there is provided an apparatus comprising: a housing having an exterior comprising a folded net of interlinked panels including a first display panel and a second display panel wherein the exterior has a first face and a second face and the first panel defines at least a portion of the first face and the second display panel defines at least a portion of the second face.

According to various, but not necessarily all,: embodiments of the invention there is provided an apparatus comprising: a housing comprising a first portion and a second portion wherein the first portion defines a first display area and the second portion defines a second display area that is touch-sensitive; and a processor configured to control an output of the second display area to change a presented touch sensitive keypad when a context of the apparatus changes.

According to various, but not necessarily all, embodiments of the invention there is provided a method comprising: distributing a first graphical user interface simultaneously over faces of an apparatus; detecting a change in context; and distributing a second graphical user interface, different to the first graphical user interface, simultaneously over faces of the apparatus.

According to various, but not necessarily all, embodiments of the invention there is provided a computer program which when executed by a processor enable the processor to: distribute a first graphical user interface simultaneously over faces of an apparatus; detect a change in context; and distribute a second graphical user interface, different to the first graphical user interface, simultaneously over faces of the apparatus.

### BRIEF DESCRIPTION OF THE DRAWINGS

For a better understanding of various examples of embodiments of the present invention reference will now be made by way of example only to the accompanying drawings in which:

FIG. 1 schematically illustrates a net of interlinked display panels according to a first embodiment;

FIG. 2A schematically illustrates an electronic device before application of the net illustrated in FIG. 1;

FIG. 2B schematically illustrates the electronic device after application of the net illustrated in FIG. 1;

FIG. 3 schematically illustrates a net of interlinked display panels according to a second embodiment;

FIG. 4A schematically illustrates an electronic device before application of the net illustrated in FIG. 3;

FIG. 4B schematically illustrates the electronic device after application of the net illustrated in FIG. 3;

FIG. 5A-5E schematically illustrates an extended graphical user interface based upon the second embodiment;

FIGS. 6A-6B schematically illustrates a context dependent extended graphical user interface based upon the second embodiment;

FIG. 7 schematically illustrates a skin;

FIG. 8 schematically illustrates another extended graphical user interface based upon the second embodiment;

FIG. 9 schematically illustrates functional components of the apparatus; and

FIG. 10 schematically illustrates a computer readable medium tangibly embodying a computer program; and

FIG. 11 schematically illustrates a method.

### DETAILED DESCRIPTION OF VARIOUS EMBODIMENTS OF THE INVENTION

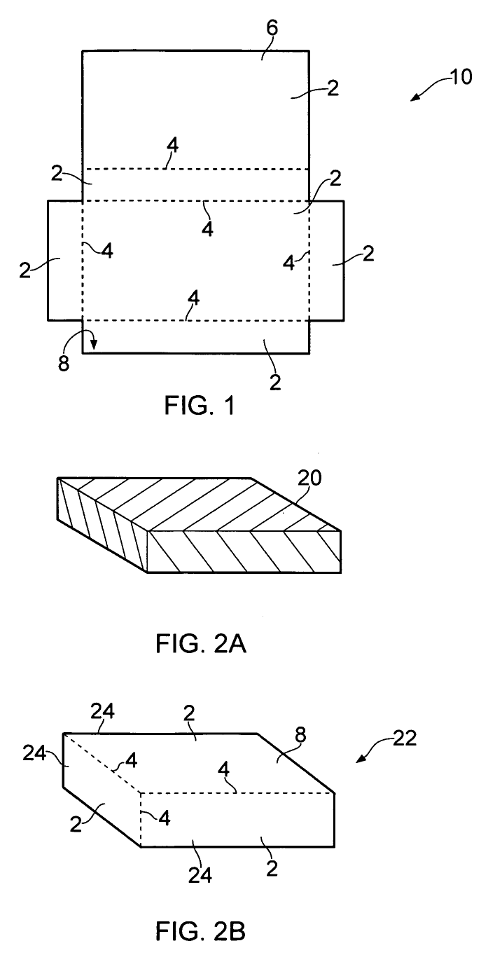

FIG. 1 schematically illustrates an example of a net 10 of interlinked contiguous display panels 2. In this example, the panels are interconnected using links 4 that enable relative hinged movement of the panels 2.

The net 10 is, in this example, monolithic in that it is formed from one-piece common material 6. Although structural defects such as for example scores have been introduced to form the links 4 between the panels, there is a common exterior surface 8 to the net 10.

The net 10 in the illustrated example comprises two rectangular main panels having opposing longer edges of a first length and opposing shorter edges of a second length; two rectangular large side panels that have opposing longer edges of the first length and opposing shorter edges of a third length; and two rectangular small side panels that have opposing longer edges of the second length and opposing shorter edges of the third length.

In the illustrated example, a first one of the main panels shares each of its two longer edges with one of the two rectangular large side panels and shares each of its two shorter edges with one of the two rectangular small side panels. There is a link 4 between each of the edges of the first main panel and the respective side panels. The second one of the main panels, in this example, shares one of its longer edges with one of the rectangular large side panels and there is a link 4 between the edges of the second main panel and the rectangular large side panel.

The net 10 of interlinked display panels 2 can be folded about the links 4 to form a cuboid wrap as illustrated in FIG. 2B. The display panels 2 can be positioned such that a plane of each display panel 2 is orthogonal to a plane of the panel to which it is linked. The cuboid has dimensions defined by the first, second and third lengths.

FIG. 2A schematically illustrates an electronic device 20 before application of the net 10 as a wrap.

FIG. 2B schematically illustrates the electronic device 20 after application of the net 10 as a wrap. The folded net 10 defines a cavity that receives the electronic device 20. The net 10 is typically applied to the electronic device 20 as part of a manufacturing process but in other implementations it could be retrofitted by a user or engineer.

The combination of electronic device and net form a hand-held apparatus 22 that has an exterior 24 formed at least partly from the exterior surface 8 of the folded net 10.

In the illustrated example, the electronic device 20 has a cuboid mono-block form and the folded net 10 conforms to the cuboid shape of the electronic device. The exterior surfaces 8 of the display panels 2 of the folded net 10 define the exterior faces 24 of the cuboid shaped apparatus 22. In the illustrated example, there are six display panels 2 that are joined via links 4.

It should be appreciated that various changes and modifications may be made to the net 10 without compromising its utility. For example, although the net 10 is illustrated as forming a cuboid this is not essential. Furthermore, it is not necessary for the folded net 10 to completely enclose the electronic device 20. The net 10 may for example have less than the illustrated six display panels. For example, one of the display panels such as a small side panel may be absent to enable easy access to a portion of the underlying electronic device 20. Access to underlying components of the electronic device may also be provided by providing cut-outs or apertures in the net 10 which in the folded configuration are aligned with the components of the electronic device 20.

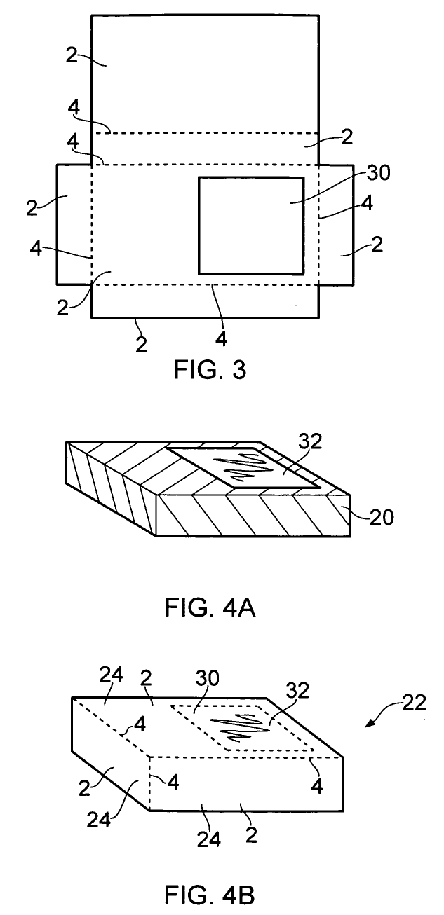

FIGS. 3, 4A and 4B respectively correspond to FIGS. 1, 2A and 2B but differ in that the net 10 according to the second embodiment has an aperture 30 which in the folded configuration is aligned with a display component 32 of the electronic device 20. The first embodiment odoes not have such an aperture 30. The aperture 30 is a hole in the first main panel of the net 10 and it extends through the net 10.

In both the first and second embodiments; the net 10 in its applied (folded) configuration provides a flexible graphical user interface (GUI) 40 that extends over multiple faces 24 of the apparatus 22. In the illustrated example, there are two main face display panels, two large side face display panels and two small side face display panels. The GUI 40 is extended in that it extends over more than one of the display panels. That is it extends from one display panel onto at least another contiguous display panel. A single graphical item may even extend over a boundary between the contiguous display panels.

A graphical user interface is a man machine interface that provides visual output to a user and may accept input from a user. The visual output may, for example, include graphical items such as pictures, animations, icons, text etc

The net 10 forms an extended display that provides more space on the apparatus 22 than a single conventional display component can offer.

The whole or parts of each of the display panels 2 in the first and second embodiments may be touch-sensitive. That is the display panels 2 may be configured to provide a display output and configured to detect a touch input. The touch sensitivity of the net 10 forms an extended touch sensitive input device that has a greater area than a conventional keypad.

FIG. 9 schematically illustrates one example of an apparatus 22. The apparatus 22 comprises a controller and a user interface 54. Implementation of the controller can be in hardware alone (a circuit, a processor . . . ), have certain aspects in software including firmware alone or can be a combination of hardware and software (including firmware). In the illustrated example, the controller is provided using a processor 50 and a memory 52.

The processor 50 is coupled to read from and write to the memory 52. The processor 50 is coupled to provide output commands to the user interface 54 and to receive input commands from the user interface 54. The processor is operationally coupled to the memory 52 and the user interface 54 and any number or combination of intervening elements can exist (including no intervening elements).

The memory 52 stores a computer program 53 comprising computer program instructions that control the operation of the apparatus 22 when loaded into the processor 50. The computer program instructions provide the logic and routines that enables the apparatus to perform the methods illustrated in the Figs. The processor 50 by reading the memory 52 is able to load and execute the computer program 53.

Referring to FIG. 10, the computer program 53 may arrive at the apparatus 22 via any suitable delivery mechanism 55. The de livery mechanism 55 may be, for example, a computer-readable storage medium, a computer program product, a memory device, a record medium such as a CD-ROM or DVD, an article of manufacture that tangibly embodies the computer program 53. The delivery mechanism may be a signal configured to reliably transfer the computer program 53.

The apparatus 22 may propagate or transmit the computer program 53 as a computer data signal.

Although the memory 52 is illustrated as a single component it may be implemented as one or more separate components some or all of which may be integrated/removable and/or may provide permanent/semi-permanent/dynamic/cached storage.

References to ‘computer-readable storage medium’, ‘computer program product’, ‘tangibly embodied computer program’ etc. or a ‘controller’, ‘computer’, ‘processor’ etc. should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other devices. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

As described above, at least part of the user interface 54 may be provided by a folded net 10 of touch sensitive display panels 2. The touch sensitive display panels 2 provide user output and detect user input. As described in relation to FIGS. 3, 4A and 4B the user interface 54 may additionally comprise a display component 32 which may be a touch sensitive display component.

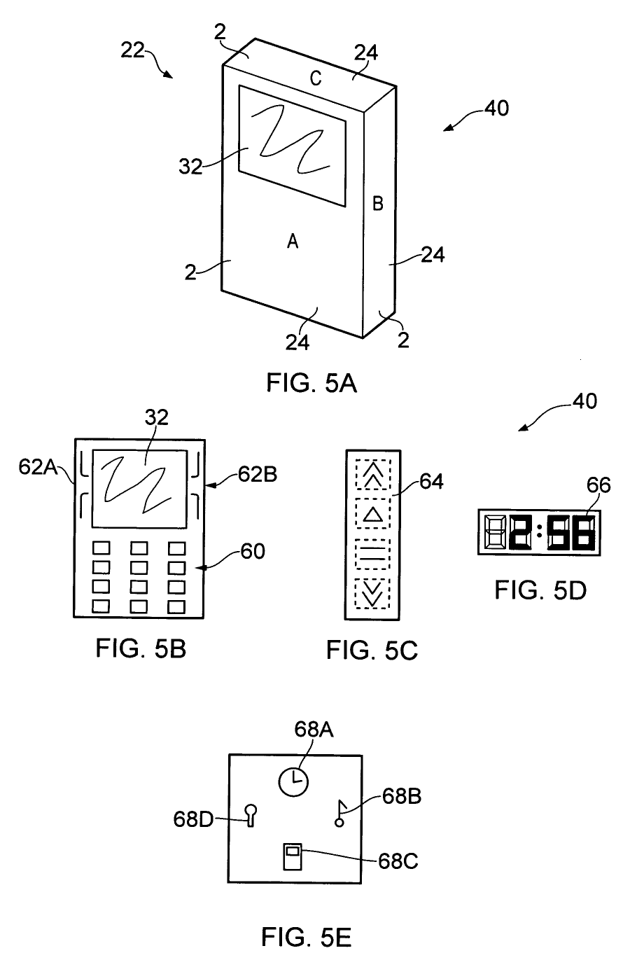

Examples of different graphical user interfaces (GUI) 40 are illustrated in FIGS. 5, 6 and 8.

The GUI 40 provided by the folded net 10 and display component 32 (if present) may be flexible in that the extent to which it covers the exterior surface 8 of the folded net 10 may be dynamically controlled by processor 50 and in that the configuration of the GUI 40 may be dynamically controlled by processor 50.

The processor 50 may, for example, vary the position and size of output display screen(s) and vary the presence, position and configuration of touch input keys. The boundaries and/or areas of the display screens may be visible by demarcation or may be invisible except that content displayed is constrained within a defined but non-demarcated area. The boundaries and/or areas of the touch input keys may be visible by demarcation or may be invisible except that touch actuation within a defined but non-demarcated area.

In the first embodiment illustrated in FIGS. 1, 2A and 2B the net is continuous and forms the whole of the graphical user interface. The processor 50 may, for example, vary the position and size of a main output display screen depending on context. The processor 50 may, for example, control the presence and vary the position and configuration of touch input keys depending on context. The net 10 may, for example, be formed from a flexible liquid crystal display (LCD)

In the second embodiment illustrated in FIGS. 3, 4A and 4B the main display is provided by the display component 32. The processor 50 may, for example, control the presence and vary the position and size of subsidiary output display screens depending on context. The processor 50 may, for example, control the presence and vary the position and configuration of touch input keys depending on context.

In the second embodiment, the display panels 2 of the net 10 may, for example, be individual bi-stable displays. The display component 32 may be any suitable display component. The ‘image quality’ of the display component 32 may be better than that of the display panels 2. For example, the display component 32 may have a faster refresh rate or it may have a greater range of colors or it may have better contrast or it may have better resolution etc.

A bi-stable display is a display that has two or more stable states. Although energy is required to change from one state to another, energy is not required to maintain a state. One form of a bi-stable display uses electrostatic charge to affect tiny spheres suspended in a plane. Another form of bi-stable display is electronic paper such as liquid-crystal dispersed in a polymer.

The use of one or more display panels 2 in combination with the display component 32 enables the whole or most of the display component 32 to be used for high quality applications such as displaying video, pictures etc whereas the display panel(s) 2 may be used for less demanding tasks such as providing slowly changing information or providing touch sensitive control keys.

FIG. 5A schematically illustrates an extended GUI 40 based upon the second embodiment illustrated in FIGS. 3, 4A and 4B. However, the principle of an extended GUI 40 is equally applicable to the embodiment illustrated in FIGS. 1, 2A and 2B.

The apparatus 22 has exterior faces 24. In FIG. 5A the front face 24 has been labeled A, a side face 24 has been labeled B and a top face 24 has been labeled C.

FIG. 5B schematically illustrates how the front face A may be used to provide a first part of the GUI 40. FIG. 5C schematically illustrates how the side face B may be used to provide simultaneously a second part of the GUI 40. FIG. 5D schematically illustrates how the top face C may be used to provide simultaneously a third part of the GUI 40.

In this example, at least the display panel 2 forming the front face A and the display panel 2 forming the side face B are touch sensitive.

It should of course be recognized that the other faces of the apparatus 22 may each simultaneously provide a part of the GUI 40. Depending upon context, different faces 24 of the apparatus 22 may be used to provide simultaneously parts of the GUI 40 and when used they may be used in different ways depending upon context.

In this illustrated example, multiple active applications use different faces 24 of the device.

For example, the first part of the GUI 40 provided by front face A is a telephone interface. In this example the touch sensitive display panel 2 provides adjacent but below the display component 32 an array of touch sensitive control keys 60 arranged as an International Telecommunications Union standard ITU-T keypad and touch sensitive control keys 62A, 62B on either side of the display component 32 for controlling calls and other features such as volume.

For example, the second part of the GUI 40 provided by side face B is a music player interface. In this example the touch sensitive display panel 2 provides a configuration of touch sensitive control keys 64 arranged as control buttons for a music player (play, pause, forward, backward).

For example, the third part of the GUI 40 provided by top face C is a clock application that display the current time 66.

Thus the GUI 40 has areas (sides) allocated to preferred applications. The allocation may be dynamic. This provides a greater area for presenting information to a user and also a greater area for providing user input controls. It also enables the whole of the display component 32 (if present) to be used for display.

One problem associated with simultaneously distributing touch sensitive control keys on multiple faces 24 of an apparatus 22 is how to avoid unwanted touch input and accidental actuation of the control keys.

The processor 50 which is configured to control the displayed configuration of control keys on the various display panels 2 of the apparatus may be configured to enable/disable input from different display panels. The processor 50 may, for example, toggle each touch sensitive display panel 2 between an input enabled state and an input disabled state. The processor 50 may detect different events and in response to the detection of a particular event toggle the state of a particular display panel 2.

For example, a particular form of touch input at a display panel 2 may toggle the input state for that display panel 2 from disabled to enabled. The state may then return to the disabled state after a timeout period and/or after a particular form of touch input at the display panel 2. The particular form of touch input may be a particular sequential pattern of distinct touch inputs or a single input having a recognizable time varying characteristic such as tracing a particular shape, such as a circle, tick, cross etc on the touch sensitive display panel 2.

The processor 50 may also place constraints on the number of touch sensitive display panels 2 that are simultaneously enabled, for example, it may only enable touch input from a single display panel 2 at a time.

The processor 50 may also provide a visual indication via the display panel 2 that indicates whether input is enabled or disabled.

The configuration of the GUI 40 may be context sensitive. A context may change as a result of user action such as dragging and dropping an icon, changing an orientation of the apparatus 22 or changing applications. Thus the GUI 40 is not static and may vary with time.

The GUI 40 provides virtual, context dependent touch sensitive control keys via the touch sensitive display panels 2 instead of static “hard” keys.

FIG. 5E illustrates an arrangement of icons 68 including a clock icon 68A, a music player icon 68B, a telephone icon 68C and a sound recording icon 68D. In one implementation, the processor 50 may be configured to enable a user to drag one of the icons 68 from the display component 32 across a particular display component 2 and then drop the icon oh that display panel 2. The processor 50 responds to the dropping of the icon on a particular display panel 2 by controlling that display panel 2 to provide a configuration of control keys and/or display elements suitable for performing the application identified by the dropped icon 68.

It may also be possible to free the display component 32 from an application that is currently occupying it by dragging and dropping that application onto a display panel 2 which is then used for that application. The display component 32 may then be returned to an idle screen or be used to display a next active application in a queue of applications.

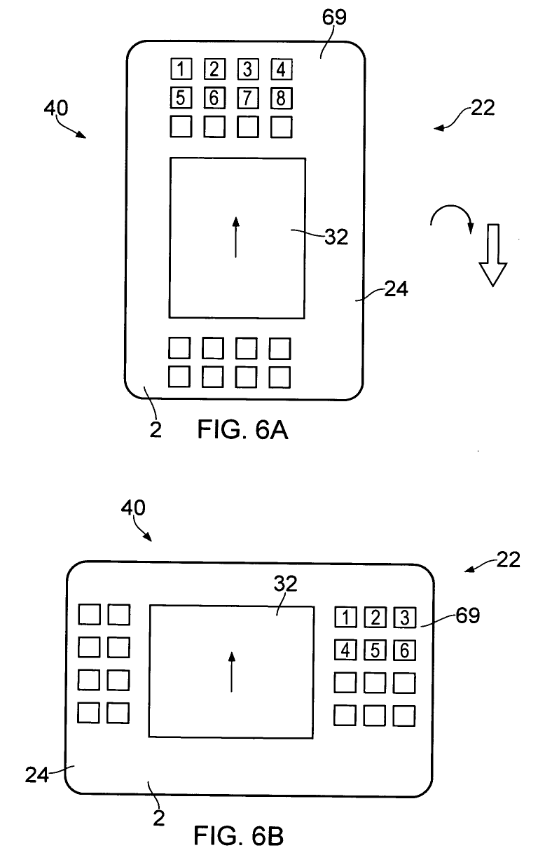

FIGS. 6A and 6B illustrate how the GUI 40 may be context sensitive. In FIG. 6A, the apparatus 22 is oriented so that the display component 32 is in ‘portrait’ and in FIG. 6B the apparatus 22 has been rotated 90 degrees clockwise (or anticlockwise) so that the display component 32 is in ‘landscape’.

In FIG. 6A, the control keys 69 provided by the touch sensitive display panel 2 are arranged in a 3 row by 4 column array whereas in FIG. 6B, the display panel 2 is controlled such that the control keys 69 provided by the touch sensitive display panel 2 are arranged in a 4 row by 3 column array.

In other embodiments, control keys such as, for example, the ITU-T keypad may only become visible when needed.

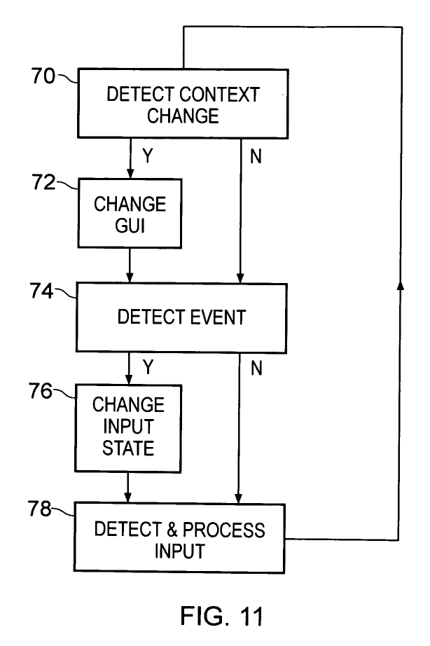

FIG. 11 schematically illustrates a method that may be performed by the processor 50 under the control of the computer program 53.

At block 70, a test is performed to detect a charged in context. If a change in context is detected, the method moves to block 72 and if a change in context is not detected the method moves to block 74.

At block 72, the GUI 40 is changed in response to the change in context. The method then moves to block 74.

At block 74, a test is performed to detect an event. An event may be associated with a change in input state for a touch sensitive display panel 2 and an identification of the touch sensitive display panel 2. If an event is detected, then the method moves to block 76 and if an event is not detected the method moves to block 78.

At block 76, the change of input state associated with the detected event is applied to the touch sensitive display panel 2 associated with the detected event. This enables/disables input via that touch sensitive display panel 2. The method then moves to block 78.

At block 78, the touch input via an enabled touch sensitive display panel 2 is detected and processed by the processor 50. The method then repeats.

The blocks illustrated in FIG. 11 may represent steps in a method and/or sections of code in the computer program 53. The illustration of a particular order to the blocks does not necessarily imply that there is a required or preferred order for the blocks and the order and arrangement of the block may be varied. Furthermore, it may be possible for some steps to be omitted.

FIG. 8 schematically illustrates another application of an extended GUI 40. In this implementation, the extended GUI 40 is used to help visually impaired persons. In this GUI 40, elements 90 that are present in the display component 32 are also displayed on the main display panel 2 with increased scale so that the elements in the display component 32 that may not be discernable are presented in a large format on the display panel 2.

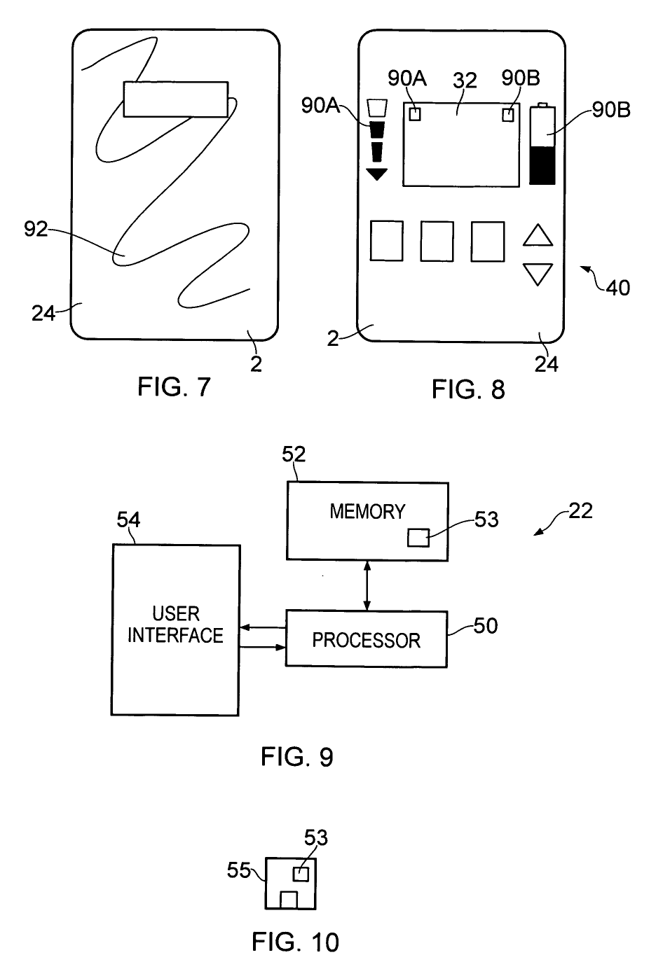

FIG. 7 schematically illustrates a further use of the folded net 10. In this embodiment, the folded net is used to display a ‘skin’ for the apparatus. The skin may be personalizable to have a character determined by a user. The skin may be animated.

The apparatus may also morph itself like a chameleon. It may for example, use the display panels to represent a cover (for example, a metallic look, brick, steel etc). It may also take the look that it wants to imitate from the surrounding environment using for example one or more cameras.

Although embodiments of the present invention have been described in the preceding paragraphs with reference to various examples, it should be appreciated that modifications to the examples given can be made without departing from the scope of the invention as claimed.

The extended GUI 40 may have one or more of the following features:
the GUI 40 may extend over multiple display faces
graphical items may seamlessly move from one display face to another. This may occur automatically as an animation or as a result of user input such as dragging and dropping the graphical item
dragging and dropping a graphical item representing an application or data structure from a first display face to a second display face may open the application or data structure in the second display face or over the whole of the extended GUI
a linear arrangement of icons may be represented using side display faces and scrolling the arrangement of icons using touch input at one side display face may scroll the arrangement of icons simultaneously on both display faces
in an idle mode, a picture or animation may automatically extend over the whole of the extended GUI
it may be possible to transfer data from one apparatus to another using near field communications or similar by bringing a first apparatus into contact with a second apparatus. The data transfer may be represented by the movement of icons from a display face of the first apparatus onto a display face of the second apparatus. The movement may occur in a manner that simulates pouring the icon from the first apparatus to the second apparatus.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

I/we claim:

1. An apparatus comprising:
a housing having an exterior comprising a first display face and a second display face arranged such that it is contiguous to the first display face; and
a processor configured to define a graphical user interface distributed simultaneously over both the first display face and the second display face.

2. An apparatus as claimed in claim 1, wherein the second display face is arranged such that it is contiguous to but not parallel with the first display face.

3. An apparatus as claimed in claim 1, wherein at least one of the first display face and the second display face are touch sensitive displays configurable to define touch sensitive control keys.

4. An apparatus as claimed in claim 1, wherein the first display face is touch sensitive and configurable to define first touch sensitive control keys and the second display face is touch sensitive and configurable to define second touch sensitive control keys.

5. An apparatus as claimed in claim 3, wherein the processor is configured to
control the displayed configuration of the first control keys
control the displayed configuration of the second control keys
in response to a first detected event enable use of the first control keys while disabling use of the second control keys
in response to a second detected event disabling use of the first control keys while enabling use of the second control keys.

6. An apparatus as claimed in claim 1, wherein the processor is configured to control an output of the first display face and change a presented touch-sensitive keypad when a context of the apparatus changes.

7. An apparatus as claimed in claim 1, wherein the processor provides content present on the first display portion in a larger font on the second display portion.

8. An apparatus as claimed in claim 1, wherein the processor controls at least one of the first display portion and the second display portion to provide a personalized skin for,the apparatus.

9. An apparatus as claimed in claim 1, wherein the exterior of the housing comprises a folded net of interlinked display panels including a first display panel and a second display panel wherein the first display panel defines at least a portion of the first display face and the second display panel defines at least a portion of the second display face.

10. An apparatus as claimed in claim 9, wherein the display panels are touch sensitive.

11. An apparatus as claimed in claim 1, wherein the net has a cut out portion for a display component.

12. An apparatus as claimed in claim 1 wherein the first display face is provided by a display component and the second display face is provided by a bi-stable display.

13. A method comprising:
distributing a graphical user interface simultaneously over both a first display face of an apparatus and a second display face of the apparatus, wherein the apparatus has an exterior comprising the first display face and the second display face arranged such that it is contiguous to the first display face; and
detecting an input from at least one of the first display face of the apparatus and the second display face of the apparatus.

14. A method as claimed in claim 13,
configuring the first display face to define first touch sensitive control keys; and
configuring the second display face to define second touch sensitive control keys.

15. A method as claimed in claim 14, comprising:
enabling use of the first control keys while disabling use of the second control keys in response to a first detected event; and
disabling use of the first control keys while enabling use of the second control keys in response to a second detected event.

16. An apparatus comprising:
a housing having an exterior comprising a folded net of interlinked panels including a first display panel
and a second display panel
wherein the exterior has a first face and a second face and the first panel defines at least a portion of the first face and the second display panel defines at least a portion of the second face.

17. An apparatus as claimed in claim 16, wherein the display panels are touch sensitive.

18. An apparatus as claimed in claim 16, wherein the net is a flexible display with a cut-out for a display component.

19. An apparatus as claimed in claim 16, wherein the net is a flexible bi-stable display.

20. An apparatus comprising:
a housing comprising a first portion and a second portion wherein the first portion defines a first display area and the second portion defines a second display area that is touch-sensitive; and
a processor configured to control an output of the second display area to change a presented touch sensitive keypad when a context of the apparatus changes.
